(19) United States
(12) Patent Application Publication
(10) Pub. No.: US 2008/0026266 A1
(43) Pub. Date: Jan. 31, 2008

(54) Fuel gas generation and supply device

(76) Inventor: Koji Kobayashi, Toyota-shi (JP)

Correspondence Address: STINSON MORRISON HECKER LLP;ATTN: PATENT GROUP, 1201 WALNUT STREET, SUITE 2800, KANSAS CITY, MO, 64106-2150, US

(21) Appl. No.: 11/879,717

(22) Filed: Jul. 18, 2007

(30) Foreign Application Priority Data
Jul. 18, 2006 (JP) 2006-195025

(51) Int. Cl. H01M 8/04; B01J 7/00; H01M 8/18

(52) U.S. Cl. 429/14; 429/19; 48/197 FM; 48/61

(57) ABSTRACT

A fuel gas generation device comprises a compartment containing a solid component and a chamber containing a liquid capable of causing a fuel gas generating chemical reaction when in contact with said solid component. A liquid permeable member is disposed between the compartment and the chamber and in contact with said solid component and a liquid supply system is disposed and arranged for delivering liquid from the chamber to the permeable member at a fixed rate. The device also includes a first chemical reaction space adjacent the permeable member where the fuel gas generating chemical reaction occurs and a second chemical reaction space linked to the first space. The volume of the first space is smaller than the volume of the second space. The device is useful for multiple purposes and generates and supplies a constant amount of fuel gas for mobile and portable fuel cells and the like continuously, stably, conveniently and inexpensively without using pressure adjusting valves and the like. The device includes a system capable of being applied to a wide range of uses for amounts of fuel gas. The operation of the device to maintain a constant reaction rate is based on the concentration of an oxidation catalyst material dissolved in the liquid, the performance of a solid oxidation catalyst material, the liquid supply rate, and/or the size of the surface area of a permeable member in contact with the liquid. The device is useful for maintaining a constant chemical reaction rate regardless or whether the oxidation catalyst is in liquid or solid form.

### CROSS REFERENCES TO RELATED APPLICATION

None

### BACKGROUND OF THE INVENTION

1. Field of the Invention

The present invention relates to gas generation and supply devices for supplying fuel gas to fuel cells continuously and at a constant rate by virtue of causing the underlying chemical reaction to proceed at a constant rate.

2. The Prior Art Background

Various storage and supply methods have been developed and proposed up to this point as fuel supply means for mobile and portable fuel cells. One attempt, a fuel supply means that makes use of a chemical reaction aimed at practical applications has come to be widely proposed as a lightweight, inexpensive method where the amount of fuel storage is greater than other methods. However, there is an urgent need for providing a practical device capable of continuously and stably supplying a constant amount of fuel gas by means of a chemical reaction that proceeds at a given a constant rate and that is small, inexpensive and convenient.

Prior related patent publications include Published Japanese Unexamined Patent Application No. 2000-161509, Published Japanese Unexamined Patent Application No. 2004-318683, Published Japanese Unexamined Patent Application No. 2005-19517, Published Japanese Unexamined Patent Application No. 2005-93104, Japanese Patent Application 2005-321503 and Japanese Patent Application 2006-082505.

Prior related Non-Patent References include Nikkei Electronics, Jun. 6, 2005, No. 901, entitled “Borohydride Enters the Fray for Portable Fuel Cells.”

### SUMMARY OF THE INVENTION

A primary object of the invention is to provide a convenient, small, lightweight and inexpensive fuel supply device capable of providing a stable supply of fuel continuously for at least several hours to a fuel cell having an output that is, for example, compatible with applications where the power requirements range from under several watts to several kilowatts or more:

A first problem encountered previously with devices such as those described above is that the rate of the fuel gas generating chemical reactions tends to decrease as a function of time as the reaction continues whereby the gas generation rate also falls with time. One major cause of this when the fuel gas is generated using an oxidation catalyst may be assumed to be a decrease in the effectiveness of the catalyst. Such decrease may be the result of a dilution of the catalyst concentration in the reaction solution resulting from retention in the reaction solution of reaction byproducts and/or contamination of the catalyst by reaction byproducts. For example, it is known that with catalysts such as malic acid, hydrochloric acid, zeolite and Nafion, the fuel gas generating chemical reaction rate falls over time with a fixed volume in a beaker or the like. Therefore, a system that provides a fixed catalyst concentration regardless of the time that has elapsed during the chemical reaction results in a constant and stable chemical reaction rate whereby to generate and provide fuel gas at a constant rate over as long a period of time as necessary.

A second problem encountered previously has been the difficulty in providing portable and/or mobile models aimed at popularization. Thus there remains a need for a supply device having a small, simple structure and that is stable, safe and convenient for use in a variety of applications. Furthermore, there is an urgent need for the provision of a basic, universal system for supplying an amount of fuel gas capable of applicability over a broad range without being limited to liquids or solids as the form of the materials used in the underlying chemical reaction.

To solve the problems mentioned above, a first aspect of the present invention provides a fuel gas generation device comprising a compartment containing a solid component, a chamber containing a liquid capable of causing a fuel gas generating chemical reaction when it comes into contact with the solid component, a liquid permeable member disposed between the compartment and the chamber and in contact with the solid component, and a liquid supply system disposed and arranged for delivering the liquid from the chamber to the permeable member at a fixed rate.

A second aspect of the invention provides a first chemical reaction space adjacent the permeable member where the fuel gas generating chemical reaction occurs, and a second chemical reaction space linked to the first space. In accordance with the concepts and principles of the invention, the volume of the first space is smaller than the volume of the second space. The volume of the first space is set so as to correspond with a reaction rate appropriate for producing a constant supply of fuel gas throughout the duration of the chemical reaction.

A third aspect of the invention provides a fuel gas generation and supply device wherein mixing of residual liquid into the fuel producing liquid solution prevented by located the first reaction space at a higher elevation than the second reaction space. This arrangement prevents dilution of the reaction solution with spent liquid as a function of time whereby to maintain a constant chemical reaction rate.

A fourth aspect of the invention provides a gas generation and supply device provided with at least one of a solid oxidation catalyst material or a hydrophilic material disposed within the first reaction space. Thus a constant fuel gas producing chemical reaction rate may be maintained without limitation on the form of the catalyst material reagent used to promote the reaction. That is to say, the catalyst may be either liquid or solid or the like.

A fifth aspect of the invention provides a gas generation and supply device wherein the fuel gas production chemical reaction rate may be controlled as a function of at least one of (1) the concentration of oxidation catalyst material dissolved in the liquid, (2) the performance characteristics the solid oxidation catalyst material, (3) the supply rate of the liquid to the permeable member, and/or (4) the surface area of the permeable member in contact with the liquid.

A sixth aspect of the invention provides a gas generation and supply device that includes at least one pressure supplying member associated with the chamber for applying constant pressure to the liquid such that the amount of liquid supplied from the chamber to the reaction area is determined by the amount of pressure applied thereto. In accordance with the concepts and principles of the invention, the pressure supplying member may desirably be a weight pressing downwardly on the liquid or a balloon-like structure pressing inwardly on said liquid. The pressure applied to the liquid may be roughly equivalent to several tens to 100 centimeters in height to produce a stable supply for several hours or more.

A seventh aspect of the invention provides a gas generation and supply device provided with a liquid supply system that includes a valve arrangement made up of a first valve structure adapted and arranged to allow the liquid to flow toward the liquid permeable member during fuel gas generating operation and to prevent reverse flow of the liquid to the inside of the chamber when the internal pressure due to the chemical reaction is at or above a prescribed level, and a second valve structure having an external operator for opening and closing the system for starting the chemical reaction by hand operation to thereby implement discretionary operations for continuing the chemical reaction and maintaining reaction pressures at a preordained level.

An eighth aspect of the invention provides a gas generation and supply device which includes a pressure supplying member adapted, arranged and disposed for urging the solid component into contact with the liquid permeable member. This member may be a weight or an elastically deformable member. Such a member is desirable because when the solid component and the liquid are in contact and the chemical reaction has continued for a long period of time (several hours or more), the solid component may adhere to the wall of the compartment and stop moving toward the permeable member because of the effect of the liquid thereon. Thus, a gap may be produced between the solid material and the permeable member resulting in a reduction and or stoppage of the chemical reaction. The presence of such a gap may be prevented by the pressure supplying member of the present invention. Which assures that the solid component is always in contact with the permeable member.

A ninth aspect of the invention provides a gas generation and supply device provided with a structure defining a water storage space located downstream from the liquid permeable member. The water storage space may desirably be located on the outer periphery of the device in a position to facilitate a simple, inexpensive and safe function that makes it possible to visually check for fuel gas leaks by bubbles or the like.

### ADVANTAGES OF THE INVENTION

A stable supply of fuel gas may be generated and supplied in a constant amount according to the above described first through fifth aspects of the invention. The parameters for producing a fixed chemical reaction rate may be set by at least one of the concentration of oxidation catalyst material dissolved in the liquid, the performance characteristics the solid oxidation catalyst material, the supply rate of the liquid to the permeable member, and the surface area of the permeable member in contact with the liquid solution. In accordance with the concepts and principles of the invention, these features play a part in the provision of a mobile device that is practical with a small, simple structure, that is inexpensive, safe and convenient to use, and that may be constructed using a resin molding or the like. A device constructed using the present concepts, is not limited to chemical reactions using a liquid catalytic solution and a solid component to produce the fuel gas. Rather, in accordance with the invention it is possible to use a solid catalyst instead of a liquid catalytic solution. In such a case, for example, a chemical reaction at a constant rate using a solid catalyst that produces fuel gas by means of reaction with tap water is possible. Furthermore, the fuel supply pressure adjustment valve that was necessary when fuel was supplied by a high-pressure tank storing a metal hydride has been made unnecessary by the present invention.

According to the sixth aspect of the invention described above, pressure energy is used to obtain a constant liquid supply rate, and, for example, when a stable supply of fuel is needed for a period of several hours or more to a fuel cell of approximately several watts or less, it is possible to provide such a supply using the present invention and a pressure equivalent to a column height of approximately 70 to 80 centimeters. Furthermore, when increased compactness is necessary, a balloon, a prescribed weight via a sealed member, or a material with elastic deformation or the like may be used to apply pressure. Applying pressure from the outside and supplying a constant amount of the liquid can be done conveniently and at low cost.

According to the seventh aspect of the invention described above, it is possible to prevent an abnormal rise in pressure due to the chemical reaction in the device and manually interrupt the chemical reaction by providing a valve arrangement including a first valve structure adapted and arranged to allow said liquid to flow toward said first space during fuel gas generating operation and to prevent reverse flow of said liquid to the inside of said chamber, and a second valve structure having an external operator for opening and closing said system. The two-way valve structure opens the circuit automatically permitting flow of liquid to the first reaction space and closes the circuit so there is no reverse flow when pressure of the chemical reaction is at or above a prescribed pressure. The second valve structure permits optionally starting or stopping the chemical reaction using an external operator.

According to the eighth aspect of the invention described above, because the weight or elastically deforming member operates to always keep the solid component in contact with the permeable member, malfunctioning of the apparatus due to the solid component being dissolved and adhering to the storage vessel wall to thereby stop movement of the same is prevented. Accordingly, contact between the permeable member and the solid component is maintained and gap formation between the permeable member and the solid component is prevented.

According to the ninth aspect of the invention, it is possible to visually check for fuel gas leaks by bubbles and the like simply and inexpensively by providing a water storage space on the outer periphery of the device. Such a space may be provided using a structure connected to the exterior of the device using, for example, integral molding of a transparent resin or the like.

### BRIEF DESCRIPTION OF THE DRAWINGS

FIG. 1 is a cross-sectional view illustrating a first embodiment of a fuel gas generation and supply device according to the present invention having a constant fuel gas production chemical reaction rate for the solid component;

FIG. 2 is a cross-sectional view illustrating a second embodiment of a fuel gas generation and supply device according to the present invention where the liquid supply means shown in FIG. 1 is changed to a balloon;

FIG. 3 is a cross-sectional view illustrating a third embodiment of a fuel gas generation and supply device according to the present invention where the structural arrangement of FIGS. 1 and 2 is replaced by a structure having increased portability;

FIG. 4 is a graph confirming that linear fuel gas generation is achieved using a chemical reaction conducted via a liquid permeable member;

FIG. 5 is a graph showing the effect of varying liquid concentration, liquid supply rate and surface area of the liquid permeable member; and

FIG. 6 is a cross-sectional diagram illustrating a conventional fuel gas generation and supply device for portable fuel cells.

### DETAILED DESCRIPTION OF THE PREFERRED EMBODIMENTS

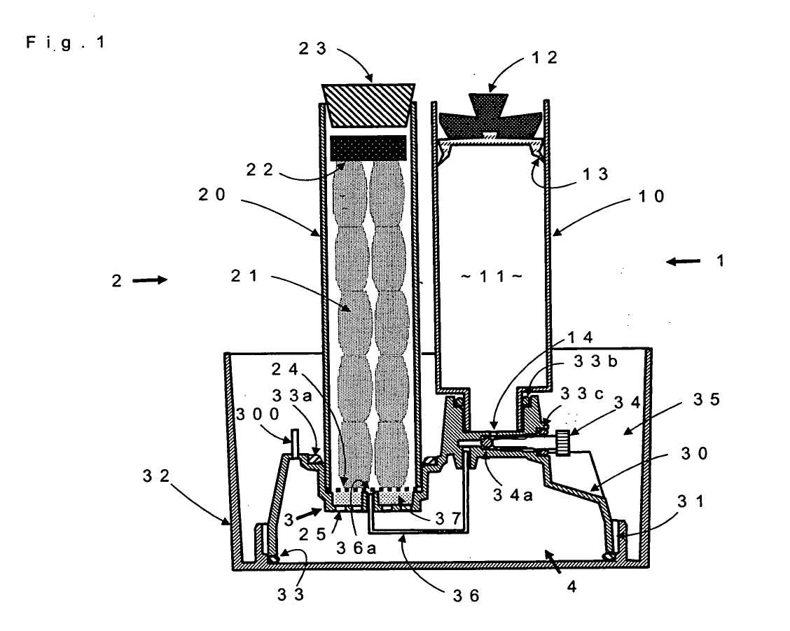

In the following detailed description, embodiments of the present invention are described with reference to the drawings. In this regard, FIG. 1 is a cross-sectional view illustrating a first embodiment of the present invention. This embodiment comprises a mobile, lightweight generation and supply device that generates and supplies a constant amount of hydrogen for use in a fuel cell or the like using a chemical reaction.

The gas generation and supply device of the present invention comprises four parts, a liquid storage body 1, a solid component storage body 2, a first chemical reaction space 3 and a second chemical reaction space 4. The storage body 1 comprises a vessel or chamber (for example, a partially or completely transparent body when there is a low-pressure, small volume hydrogen gas supply of approximately 0.1 Pa or less) 10 and a weight 12 provided with a sealing member 13. Vessel 10 stores a catalyst solution (for example, a malic or hydrochloric acid solution or the like) 11 prepared in advance in a prescribed concentration. The body 10 also includes a supply opening 14 for the solution. The storage body 2 presents a compartment 20 for storing a solid component 21. The solid component 21 and the liquid 11 are capable of causing a fuel gas generating chemical reaction when the same come into contact with one another. Such reaction is generally promoted by the catalyst in liquid 11. Thus, fuel gas is generated in vessel 20. The solid component 21 is kept in contact with a permeable member 24 capable of transmitting the solution 11 and disposed in the lower part of the compartment 20 by the weight of a weight 22 disposed on top of component 21. The compartment 20 is sealed off from the outside by a seal member 23 disposed at the top of compartment 20.

The flow of solution 11 from chamber 10 may be stopped or started from the outside using a seal member 34a provided adjacent the inner tip of a valve structure 34. When the valve 34 is opened, the solution 11 is supplied to the lower part of the storage body 2 via a supply means in the nature of a pipe 36 from at least one outlet 36a. The solution 11 thus supplied passes through the permeable member 24 and causes a chemical reaction with the component 21 whereby to generate the fuel gas. The chemical reaction takes place in the neighborhood of the place where the component 21 contacts the permeable member 24, and since the storage body 2 is a closed space because of the seal member 23, the residual reaction solution and the fuel gas that is generated by the reaction are present in the first reaction space 3. Furthermore, the reaction solution in the space 3 flows out into the second reaction space 4 through a distribution opening 25, and the chemical reaction also continues there. The volume of chemical reaction space 3 is pre-selected so as to avoid dilution of solution 11 as a function of reaction time so that the latter may be carried out continuously and at a prescribed chemical reaction rate. In other words, when the component 21 is borohydride (NaBH₄), for example, the amount of the solution 11 necessary for continuously generating 146 cc of fuel gas per minute (a class comparable to a fuel cell with a 20 W output) for several hours is approximately 0.06 g per minute in a theoretical chemical equation, but as a result of our experiments, five to seven times that amount of solution is actually necessary. Furthermore, since gas production is actually conducted in a gas bubble state at the chemical reaction site, approximately 1 to 4 cc is necessary to continuously produce the desired amount. Furthermore, the total amount of the solution 11 necessary for operating continuously for several hours is approximately 22 g in a theoretical chemical equation, but in the results of our experiments, approximately 5 to 7 times that, in other words approximately 120 cc, is actually necessary to produce the desired amount of hydrogen. Furthermore, the position of the first reaction space 3 is more elevated than the position of the second reaction space 4, such that the solutions in the two spaces do not become mixed. Therefore, the concentration of the solution 11 in the first chemical reaction space 3 does not change but rather, the initial concentration is maintained without the solution becoming diluted. Thus, the reaction rate is held constant. In addition, a hydrophilic material 37 may be provided in the first chemical reaction space 3, and this facilitates uniform contact of the solution 11 with the permeable member 24 and prevents wasteful dripping of the same into the second reaction space 4.

The fuel gas generated in the first and second reaction spaces 3 and 4 is discharged via the outlet 300. In addition, the second reaction space 4 is presented by the lower portion of a transparent vessel 32 and a joining structure 30. Structure 30 is joined to the vessel 32 using a seal material 33. Furthermore, a space 35 is provided at a position above the various connection seals 31, 33a, 33b and 33c for the gas generation device; so it is convenient to check for gas leaks from each of the connection seals by visual confirmation based on the absence or presence of bubbles. This of course improves the safety of the device.

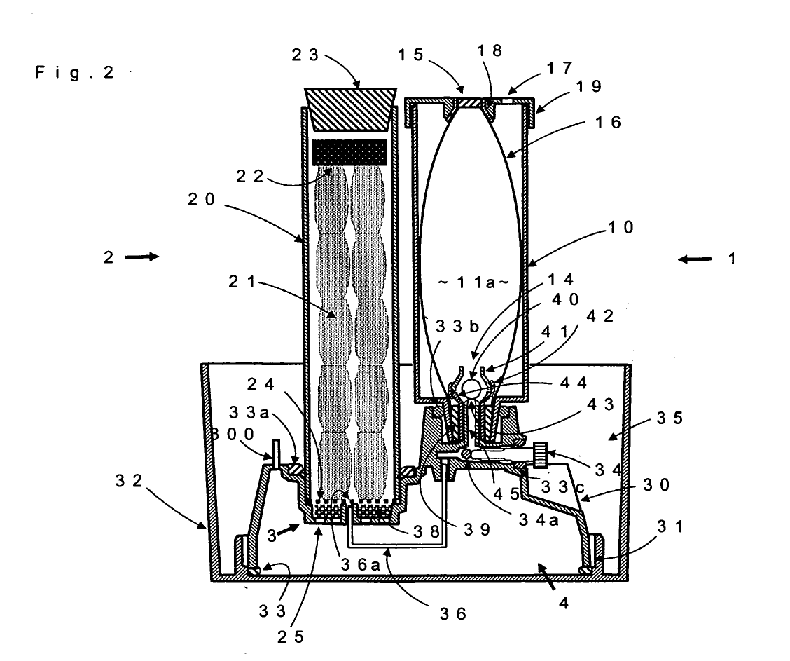

FIG. 2 is a cross-sectional view illustrating second embodiment of a hydrogen gas generation and supply device of the present invention. This second embodiment device also supplies the solution 11 at a constant rate, but in this case the weight 12 of FIG. 1 is replaced by a balloon 16. Also, the hydrophilic material 37 of FIG. 1 is replaced by a solid oxidation catalyst material 38. Otherwise, the elements of the device are essentially the same as the elements of the device of FIG. 1, and the numbering of the elements of FIG. 2 corresponds with numbering of the elements of FIG. 1 whereby duplicate descriptions are omitted.

Instead of the catalyst solution 11, tap water 11a is stored in the balloon 16. An elastic seal material 15 is disposed at the top of the balloon 16. The seal material 15 is capable of having the solution 11 a injected from the outside using an injection needle or the like. The device also includes a cover 19 having a fastening part 18 and an opening 17. At the bottom of the device, the lower end of the balloon 16 is squeezed between a reduced diameter portion of vessel 10 and an elastic material 39. The reduced diameter portion of vessel 10 is sufficiently inserted into an opening in structure 30 and sealed in place using a seal material 33b. The device of FIG. 2 includes a valve arrangement including a valve structure adapted and arranged to allow liquid 11a to flow toward liquid permeable member 24 during fuel gas generating operation and to prevent reverse flow of said liquid to the inside of vessel 10. The valve arrangement is disposed within the supply opening 14 and the same includes an outlet connection pipe 45 disposed within a ball valve pipe structure 42 having an expanded cavity 44 therein and a seal part 41 at its upper end. A ball 40 is disposed within cavity 44 as shown. Pipe 45 is provided with a notched part 43 at its upper end. In operation, ball 40 separates downwardly from seal part 41 and rests on notched part 43 so that solution 11a may flow outwardly through pipe 45. On the other hand, reverse flow of solution 11a is prevented because ball 40 will be pushed upwardly and into sealing relationship with the center of seal part 41. Therefore, it is possible to freely set the supply rate for the tap water 11a by pre-selecting an appropriate coefficient of elasticity for the balloon. Furthermore, the consumption status can be checked visually. The tap water 11 a supplied from the pipe 45 is supplied to the liquid permeable member 24 from at least one supply opening 36a, and the solid component 21 that is in contact with that member 24 is dissolved. The solution promotes the chemical reaction using the solid oxidation catalyst material, and the mechanism for generating the gas is the same as for FIG. 1.

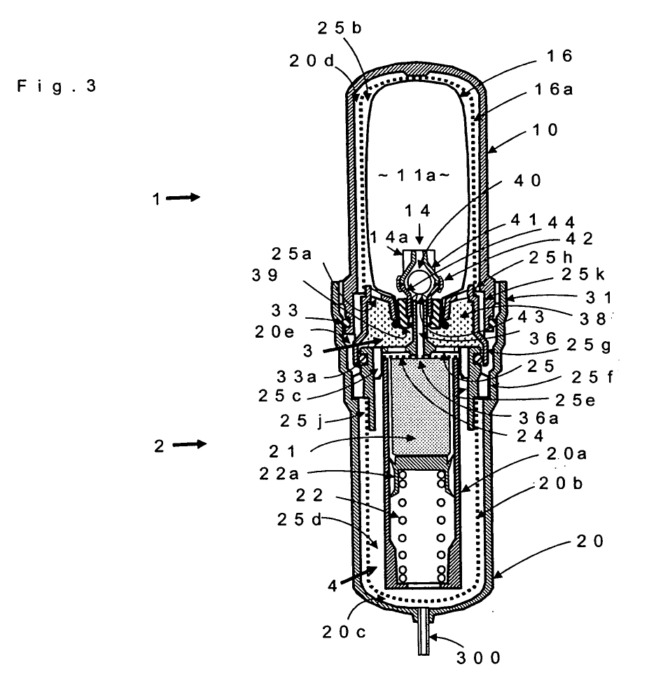

FIG. 3 is a cross-sectional view illustrating a third embodiment of a hydrogen gas generation and supply device of a third embodiment constructed in accordance with the principles and concepts of the present invention. This third embodiment comprises four parts, the liquid storage body 1, solid component storage body 2, the first chemical reaction space 3 and the second chemical reaction space 4 as with previous embodiments 1 and 2. But the device of FIG. 3 is particularly valuable for use in portable applications. In this regard the operating systems are the same but the physical arrangement of the parts is different. Therefore, the same element numbers are given to corresponding parts in FIG. 3, and duplicate descriptions are omitted.

Liquid 11a is supplied to the surface of the liquid permeable means 24 from at least one outlet 36a by the supply means 36, and the solution la that causes the chemical reaction with the solid component 21 flows from the flow opening 25 and into the first reaction space 3 surrounded by the vessel part 25g. Furthermore, the chemical reaction continues in spaces 25b and 25d that constitute the second reaction space 4 from through holes 25a and 25c. In the space 25b, the balloon 16 contracts with the consumption of the tap water 11a, and the space 25b is thus expanded. The fuel gas generated by the chemical reaction passes through gas permeable members 16a and 20b, which prevent the passage of liquids, and the fuel gas flows to spaces 20c and 20d, which are connected by a communicating groove 20e having joined parts 25h and 25j. The fuel gas then passes to a supply opening 300. The vessels 25e and 25g are joined to the vessels 20 and 10, respectively, by the joining parts 25f and 25k. The solid component 21 operates so as to be in contact with the surface of the liquid permeable member 24 via a piston 22a provided with a sealing means by an elastic deforming member (corrosion resistant spring, rubber or the like) 22. Therefore, it can be seen that the present embodiment is based on the concept of the present invention. In addition, when there is a single storage body 1, the ball 40 is in contact with a seat 41 but allows the tap water 11a to be infused into the balloon 16 via the notch part 14a if the tap water 11a is fed under pressure from the outside to the supply opening 36 in filling the balloon 16 with tap water 11a.

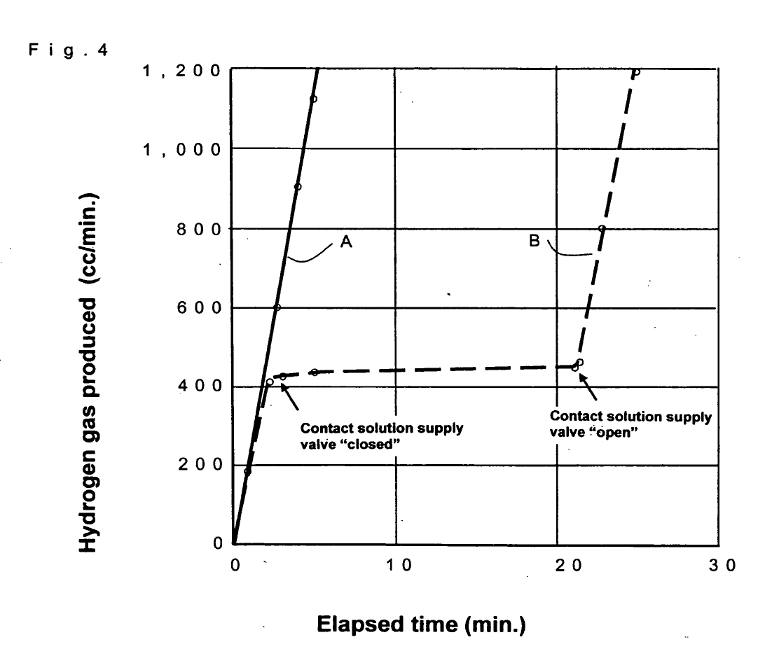

FIG. 4 is chart showing an example of test results verifying the constant chemical reaction rate that is the basis of the present invention. In this example, the surface area of the liquid permeable member 24 is 3.6 cm², the concentration of the catalyst solution 11 is 0.8 molar, and the liquid supply rate is 0.5 cc/min. As is shown in by curve A, which is the case of a continuous chemical reaction, the reaction rate is verified as being linear. In addition, the graph of temporarily “opening”/“closing” the supply of the catalyst solution is curve C. As is shown by this curve C, even if the supply of the catalyst solution 11 is completely stopped, the chemical reaction does not immediately stop after the supply is stopped. In addition, it can be seen that a small chemical reaction continues while it is flow is stopped and it does not completely go to “zero.” However, after reopening, the response for the chemical reaction is good compared with the “closed” period. From these results it can be seen that this system sufficiently provides responsiveness in the chemical reaction.

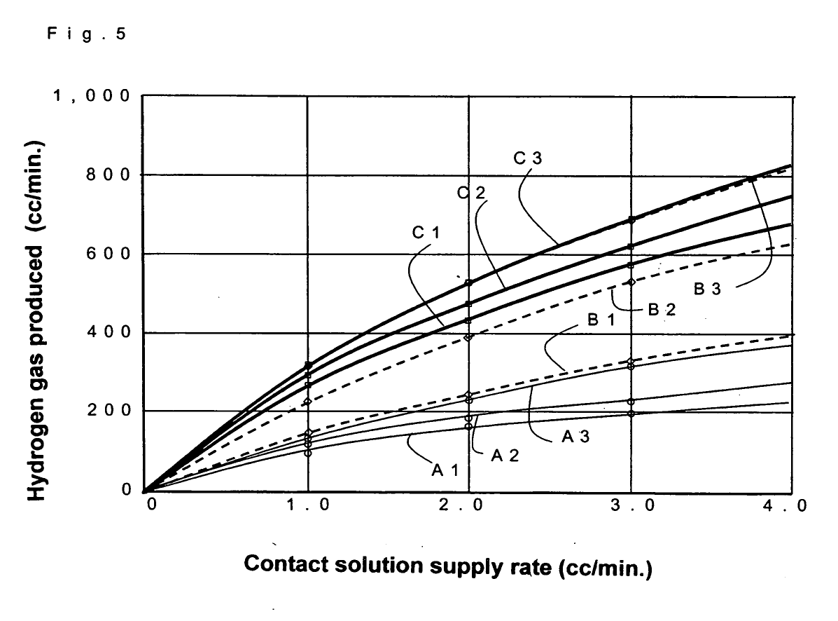

FIG. 5 is a chart illustrating examples of test results showing the degree of the effect with changes in the setting parameters for the chemical reaction rate, on the characteristics of at least one of the concentration of the oxidation catalyst material solution dissolved in the liquid and the performance of the solid oxidation catalyst material as well as the level of the size of the area where the permeable member is in contact with the liquid, which is the main point of the present invention, to confirm the practicality of the present invention. The reagent used in these test examples was malic acid for the catalyst solution 11 with borohydride used for the solid component 21, and it was a case that contemplated a fuel cell output of approximately 100 W or less.

For one of the test results for the case described above, three standards for the concentration of the solution 11 are shown in three curves, 0.2 molar in curve A1, 0.6 molar in curve A2 and 1.0 molar in curve A3, for the case where the area of the permeable solution infiltration material was 0.9 cm². The degree of the effect on the amount of fuel gas produced in accordance to the concentration can be read from these three curves. In the same manner, for a second set of tests, three results are shown in curves using 2.6 cm² as the area of the permeable solution infiltration material, with a 0.2 molar solution concentration in curve B1, a 0.6 molar solution concentration in curve B2 and a 1.0 molar solution concentration in curve B3, and for a third set of tests using a 3.6 cm² infiltration area with a 0.2 molar solution concentration in curve C1, a 0.6 molar solution concentration in curve C2 and a 1.0 molar solution concentration in curve C3. These results back up the fact that the parameter settings according to the present invention are effective and that the degree of the effects of the parameters may be suitably grasped. In the examples of test results, the concentration of the catalyst solution and the supply rate were changed linearly, but this may be thought of as being due to causes peculiar to the actual equipment in the system that was used for these tests. However, since results that are reproducible according to the levels of each of the characteristics were obtained, it is possible to judge that it is at a level for which reduction to practice can be sufficiently investigated.

Furthermore, from the results of these tests, it is possible to minimize the amount of catalyst solution consumed when obtaining a prescribed amount of hydrogen gas. In other words, when, for example, the amount of hydrogen gas required is set to 146 cc per minute in a fuel cell in the 20 W output class, the minimum value is an amount of approximately 0.5 cc with curve B3, which is substantially the same as curve C3 where the surface area of the solution infiltration material is large at 3.6 cm². On the other hand, the results for the maximum value are approximately 2 cc per minute with a small surface area of 0.9 cm² for the solution infiltration material. Moreover, the concept of the present invention does not stop at results within the scope of these experiments, and for example, the results may vary according to the material characteristics of the infiltration material 24, the temperature characteristics and the like, but it is sufficiently possible to apply the present method even when it is necessary to consider these characteristics.

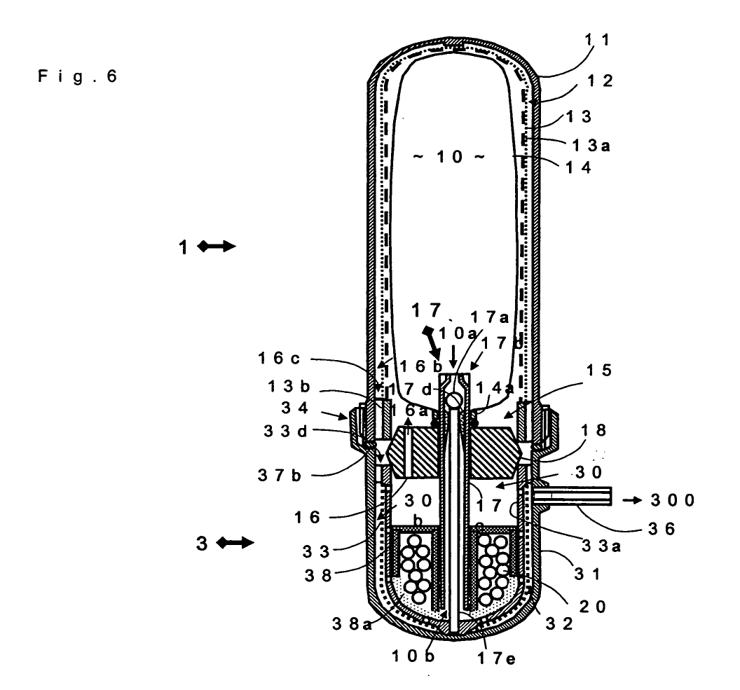

FIG. 6 is a cross-sectional view showing a conventional fuel gas generation and supply device. This drawing is one where the liquid supply means 1 and the space 3 where the liquid 10 is directly supplied to the solid component and the chemical reaction brought about are provided. Therefore, it is different from a chemical reaction system predicated on a chemical reaction of the solid component that generates the fuel gas with a prescribed surface area via a liquid permeable member, which is the main point of the present invention. In other words, since the present invention does not directly supply the liquid to the solid component, it is a system where it is possible to stably continue a constant chemical reaction rate over a long period of time of several hours and have a linear fuel gas generation over a long period of time.

### Effects of the Embodiment

According to the embodiments discussed above, three elements, that is at least one of the concentration of the solution of the oxidation catalyst material dissolved in the liquid and the performance of the solid oxidation catalyst material, as well as the liquid supply rate and the size of the surface area of the permeable member in contact with the liquid are basically used as the most fundamental parameter design for continuation of the necessary amount of fuel gas and giving a stable supply. Furthermore, according to the invention, applications can be developed into device design for estimation of the range of variation or creating series of fuel gas supply amounts by adding additional parameters (temperature characteristics, material characteristics and the like) with the same concept. Even further, inexpensive, easy construction of the device is possible based on typical resin materials, and it is possible to use typical transparent materials that are easily acquired. It is possible to easily visually check the state of material consumption and gas leaks that cannot be seen with the eye. As a new mode for supplying fuel to fuel cells that have applications for outputs of several watts or less to those that exceed several kilowatts, for example, the path toward being able to have applications with various uses in mobile models and portable models may be opened seamlessly. In addition, with the present invention there is the merit that with the present device, a regulator valve that adjusts the supply of gas pressure from the constant amount of gas generated is unnecessary.

### Other Embodiments

In the embodiments illustrated by FIGS. 1 to 3, it is possible, based on the concepts of the present invention, to consider the material for the vessel 20 used for always having the solid component 21 in contact with the liquid permeable member 24, and the shape and size of the solid component 21 may be set to, for example, a rod shape and size, an approximately 10 to 15 mm pellet shape, an approximately 2 to 3 mm grain shape or the like in consideration of the prescribed amount of fuel gas being generated and convenient sealing and storage for safekeeping. Furthermore, for example, it is also possible to develop applications involving solid catalysts where malic acid and the like are solidified with starch and the like. In addition, for the liquid supply means 36 there are developments involving at least partial uses of fiber materials (for example, osmotic pressure with the use of cotton thread and the introduction of fishing line) in the supply means for adjustment other than by the surface area and length of the liquid flow for adjusting the liquid supply rate.

Furthermore, in connection with the embodiments of FIGS. 1 to 3, there are many types of construction structures and arrangements that may be used for the liquid storage body 1, the solid component storage body 2, the first chemical reaction space 3, the second chemical reaction space 4 and the like including the sealing methods But no matter what the arrangement is for the storage body 2 for a solid component having a chemical reaction function through the liquid permeable member 24 that provides a prescribed chemical reaction surface area, the first chemical reaction space and/or the second chemical reaction space, all systems provided with the storage body 1 that have a function for supplying a prescribed amount of liquid are basically included in the present invention.

I claim:

1. A fuel gas generation device comprising:
a compartment containing a solid component;
a chamber containing a liquid capable of causing a fuel gas generating chemical reaction when it comes into contact with said solid component;
a liquid permeable member disposed between the compartment and the chamber and in contact with said solid component; and
a liquid supply system disposed and arranged for delivering said liquid from the chamber to the permeable member at a fixed rate.

2. A fuel gas generation device as set forth in claim 1, wherein is included a first chemical reaction space adjacent said permeable member where said fuel gas generating chemical reaction occurs, and a second chemical reaction space linked to said first space, and wherein the volume of said first space is smaller than the volume of said second space.

3. A fuel gas generation device as set forth in claim 2, wherein said first reaction space is disposed at a higher elevation than said second reaction space.

4. A fuel gas generation device as set forth in claim 2, wherein a solid oxidation catalyst material is disposed within said first reaction space.

5. A fuel gas generation device as set forth in claim 3, wherein a solid oxidation catalyst material is disposed within said first reaction space.

6. A fuel gas generation device as set forth in claim 2, wherein a hydrophilic material is disposed within said first reaction space.

7. A fuel gas generation device as set forth in claim 3, wherein a hydrophilic material is disposed within said first reaction space.

8. A fuel gas generation device as set forth in claim 1, wherein is included at least one pressure supplying member associated with said chamber for applying constant pressure to the liquid such that the amount of liquid supplied to the first space is determined by the amount of pressure applied thereto.

9. A fuel gas generation device as set forth in claim 8, wherein said pressure supplying member is a weight pressing downwardly on said liquid.

10. A fuel gas generation device as set forth in claim 8, wherein said pressure supplying member is a balloon-like structure pressing inwardly on said liquid.

11. A fuel gas generation device as set forth in claim 2, wherein is included at least one pressure supplying member associated with said chamber for applying constant pressure to the liquid such that the amount of liquid supplied to the first space is determined by the amount of pressure applied thereto.

12. A fuel gas generation device as set forth in claim 8, wherein said liquid supply system includes a valve arrangement including a first valve structure adapted and arranged to allow said liquid to flow toward said liquid permeable member during fuel gas generating operation and to prevent reverse flow of said liquid to the inside of said chamber, and a second valve structure having an external operator for opening and closing said system.

13. A fuel gas generation device as set forth in claim 11, wherein said liquid supply system includes a valve arrangement including a first valve structure adapted and arranged to allow said liquid to flow toward said first space during fuel gas generating operation and to prevent reverse flow of said liquid to the inside of said chamber, and a second valve structure having an external operator for opening and closing said system.

14. A fuel gas generation device as set forth in claim 1, and a pressure supplying member adapted, arranged and disposed for urging said solid component into said contact with said liquid permeable member.

15. A fuel gas generation device as set forth in claim 2, and a pressure supplying member adapted, arranged and disposed for urging said solid component into said contact with said liquid permeable member.

16. A fuel gas generation device as set forth in claim 1, and structure defining a water storage space located downstream from said liquid permeable member.

17. A fuel gas generation device as set forth in claim 2, and structure defining a water storage space located downstream from said first and second chemical reaction spaces.

18. A method for operating a fuel gas generation device as set forth in claim 1, wherein the chemical reaction rate is controlled as a function of at least one of (1) the concentration of oxidation catalyst material dissolved in said liquid, (2) the performance characteristics the solid oxidation catalyst material, (3) the supply rate of said liquid to the permeable member, and (4) the surface area of said permeable member in contact with said liquid.

19. A method for operating a fuel gas generation device as set forth in claim 2, wherein the chemical reaction rate is controlled as a function of at least one of (1) the concentration of oxidation catalyst material dissolved in said liquid, (2) the performance characteristics the solid oxidation catalyst material, (3) the supply rate of said liquid to the first space, and (4) the surface area of said permeable member in contact with said liquid.

20. A method for generating fuel gas comprising:
providing a solid component;
providing a liquid capable of causing a fuel gas generating chemical reaction when in contact with said solid component;
providing a liquid permeable member having one side disposed in contact with said solid component and a second side; and
delivering said liquid to the second side of the permeable member at a fixed rate.

21. A method for generating fuel gas comprising:
providing a solid component;
providing a liquid capable of causing a fuel gas generating chemical reaction when in contact with said solid component;
providing a liquid permeable member having one side disposed in contact with said solid component and a second opposite side; and
delivering said liquid to a reaction space located adjacent the second side of the permeable member;
providing an oxidation catalyst at said space,
wherein the fuel gas generating chemical reaction rate is controlled as a function of at least one of (1) the concentration of oxidation catalyst material dissolved in said liquid, (2) the performance characteristics the oxidation catalyst material, (3) the supply rate of said liquid to the reaction space, and (4) the surface area of said permeable member in contact with said liquid.
